(19) United States
(12) Patent Application Publication
(10) Pub. No.: US 2008/0223487 A1
(43) Pub. Date: Sep. 18, 2008

(54) Selection and bundling method for random length materials

(76) Inventor: Robert Ahrens, Lincoln, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/717,830

(22) Filed: Mar. 13, 2007

(51) Int. Cl. B27C 9/00

(52) U.S. Cl. 144/41

(57) ABSTRACT

An apparatus for selecting and sorting a plurality of random length boards to form at least one row of boards having a total length within a predetermined target length range includes a measurement section operative to measure the length of each board and a sorting section which includes a sorting device and system for sorting the boards. An accumulating row section accumulates and stores rows of boards selected from the plurality of boards and a vacuum suction transport device moves rows of boards from the accumulating rows to a bundling section which receives rows of boards and then bunches and aligns the rows of boards and bundles the rows of boards in a board row bundle. Finally, a central processor performs all calculations and controls to properly sort the boards to create bundles of rows of boards having a total length generally within a predetermined target length range.

### BACKGROUND OF THE INVENTION

1. Technical Field

The present invention relates generally to methods for selecting random length materials such as wood flooring stock and bundling nested combinations of the stock into a standard length, and more particularly to an improved method for selecting, sorting and bundling plurality of random length stock into generally standard length combinations for compiling and bundling.

2. Description of the Prior Art

Solid wood flooring is typically produced in random lengths, which vary from nine inches to eight feet long. The length is determined by cuts made to remove randomly placed defects in the natural raw material.

The flooring stock is typically shipped in standard bundles ranging from seven to eight feet long, and therefore the flooring stock is conventionally bundled in one or two ways: (1) sorting by length to the nearest even foot in length, with various length bundles included on a single pallet; and (2) nesting various lengths of wood stock into a standard bundle, typically seven to eight feet long. In either case, the top layer of flooring in each bundle is inverted, so that the face of the product is protected from damage during shipping and handling.

Nesting is becoming the preferred method of bundling, because it is easier to handle and ship and typically assures a random assortment of lengths for the installer. The most popular method for assembling random length wood flooring into nested bundles uses people to manually assemble the bundles. Generally, a person will first determine the grade of the flooring board by visual inspection. The inspected stock is then placed into a rack and sorted by its approximate length. A person on the other side of the rack will then remove selected pieces from one or more slots in the rack, visually judging the lengths to make a row of the desired standard length, when the pieces are nested end to end. In this method, the wood stock is generally sorted into approximate one foot increments. However, rarely are the boards exactly cut to the foot, and therefore are either longer or shorter than the increment slot in the rack in which it is placed. For this reason, once a combination of pieces is selected by the person assembling the bundle, it is often necessary to remove and replace various pieces to adjust the overall length of the nested row to fit the predetermined standard.

On the other hand, if the person grading the stock sorts the stock into racks with smaller increments, the sorting rack must necessarily be larger, and more time must be spent determining the proper slot in the rack for storage, as well as determining appropriate lengths for selection and nesting into the desired predetermined length row. In some cases, a separate automated sorting mechanism is used to sort the wood stock by approximate length after grading. However, the nesting process is still currently accomplished manually by people. After enough rows of a proper length have been selected (usually twelve to fifteen rows for standard strip flooring) the top layer of product is manually inverted to protect the upper face of the product. The bundle is then tied together with plastic straps by a banding machine and the bundles are palletized for shipping.

As each row of nested lengths are assembled into a stack forming a bundle, each row is typically abutted flush, allowing the distal ends of the rows to vary. Thus, the bundle will typically include a proximal end with all rows abutted flush, and a distal end with a “jagged” appearance because of the various completed lengths of rows. In an alternative bundling method, each end of the pieces of material are abutted against stops, forming flush ends, with the gaps between nested pieces located in the middle of the bundle. Frequently, the interleaving of the pieces in this particular method is not adequate to hold the bundle together and the bundle is not as secure when bound. This method also makes it more difficult to estimate the total actual footage of the material in the bundle. Because the longest and shortest rows in the bundle are typically four to six inches longer or shorter than the predetermined average, longer pallets are necessary for shipping and storage.

In forming a “jagged end” bundle, the bundle assembler typically starts with a long piece of wood stock, or a combination of short pieces, and then chooses a short piece that will nest with the initial piece or pieces to approximate the desired predetermined length. This results in most of the short pieces being located at the jagged end of the bundle, which can then be easily dislodged from the bundle during handling and shipping. Frequently, when a truck or container of flooring is opened at its destination, dozens of short pieces of flooring have fallen from the bundles, with no way of determining which piece belongs to which bundle. This in turn results in a shortage of wood product from bundles, to the end user.

The process of assembling bundles is further complicated by the measuring rules commonly used in this industry. A standard machining or “end matching” allowance of ¾ inch is allowed on each piece of flooring. End matching is the process of putting a groove on one end of a piece of flooring stock and a tongue on the other end. The tongue and groove then interlock to prevent displacement of the ends of the flooring over time. The standard method of measurement for wood flooring calls for the addition of ¾ inch to the length of the face of each piece, in order to allow for the material which is necessarily removed by the end matching process. This means that, if a row is being assembled for a standard length bundle, it may be ¾ inch short if the row consists of one piece of wood stock, 1½ inches short if made up of two pieces of wood stock, etc. In practice, the average length is assumed, and the target bundle length is shortened by the required amount.

Industry grading rules also require a minimum average length for each grade. The system of the present invention allows the processor to easily keep track of this information. The current process of creating nested rows to form bundles by hand is time consuming, tedious, and proficiency requires consider experience. Some bundle assemblers never become good at choosing an acceptable combination of wood stock lengths on the first or second try, and therefore must spend additional time in a trial and error process to form a bundle. Further, the manual process of selecting rows for a bundle is not particularly accurate when assembled by hand, especially if the person assembling the bundle is in a hurry to create the bundle. Further, once assembled, it is difficult to obtain an accurate measure of the material which is included in each bundle, especially if the method of forming the bundle with two flush ends is utilized.

Several methods and devices have been proposed in the prior art, including Ahrens, U.S. Pat. Nos. 6,510,364 and 6,598,747. While the previous Ahrens patents do address many of these issues, the method used has some limitations. The measurement method is not particularly accurate, and may change as the feed wheels wear and is affected by feed wheel slippage. Also, the speed at which the Ahrens machine operates is not adequate to handle the production of a large flooring mill. It is designed to handle only one grade, and is not easily adapted to multiple grades. No provision is made for automation in loading the machine. Graders must still handle the boards in order to grade and load the machine. Finally and perhaps most importantly, however, the prior art method of Ahrens utilizes an entirely different sort method, specifically that it accumulated up to 16 individual boards in a storage rack and then determined the preferable solution consisting of one or more boards to form a row within the minimum and maximum tolerances. The number of possible combinations available in this scenario, however, is in the millions, and even after computing all of these combinations, the end result is only a single completed row, which greatly increases the inefficiency of the sorting process.

It is therefore a general object of the present invention to provide an improved bundling method for selecting random length pieces of product to form standard length bundles. This improved method is designed to analyze individual boards as they are fed into the sorting apparatus and determine on the fly where those boards should be sent to provide the best fit in each row to form a row having an overall length which falls within a predetermined length range for preparing bundles of product which are of generally similar length.

Another object is to provide a sorting and bundling method which is automated to improve the accuracy of the overall length of rows within a bundle and the average bundle size.

A further object of the present invention is to provide a sorting and bundling method which is capable of documenting the length of pieces within a bundle more accurately than possible when assembled by hand or by use of the disclosed prior art.

Still another object is to provide a sorting and bundling method which is capable of tracking minimum average length information for each grade of product. Also, the improved method gives the operator the option of maintaining an average length for a given grade of product by any of several methods. If the average length of the current production run is less than the desired target, the machine may reject short boards, downgrade short boards to a grade with lower average length requirements, or bundle short boards as a separate grade, allowing them to be sold as such, or blended back into production when the average length is more than required. The last is the preferred solution, since it allows full price to be realized for the short pieces and also improves consistency of product.

Finally, an object of the present invention is to provide an improved sorting and bundling method which is relatively simple and accurate in application is safe, efficient and effective in use.

### SUMMARY OF THE INVENTION

The present invention provides a method for selecting and sorting a plurality of random length boards to form at least one row of boards having a total length within a predetermined target length range, the method comprising the steps of measuring the length of each of a plurality of random length boards and then feeding each of the plurality of random length boards into a programmable sorting device. The method then sorts each of the plurality of random length boards via the programmable sorting device into a plurality of accumulating rows to fill at least some of the plurality of accumulating rows with selected boards from the plurality of random length boards such that the selected boards in at least some of the plurality of accumulating rows form rows of boards having a total overall length within a predetermined target length range and each row of boards having a total overall length within a predetermined target length range is selected and transferred via a board row transfer device from at least one of the plurality of accumulating rows to a bundling device. Finally, the selected and transferred rows of boards are bundled via the bundling device by generally bunching, aligning and securing the rows of boards in a generally longitudinally aligned board row bundle.

The present invention as thus described provides substantial advantages over those board sorting and bundling methods found in the prior art. For example, because the present invention sorts the boards as they are processed through the apparatus in a generally continuous fashion, the efficiency of the process and the efficiency of operation of the apparatus is increased significantly over previous devices and methods. Furthermore, because the present invention and method automates the sorting and bundling process, users of the present invention will see large savings in labor and expense over those prior art devices and methods, which will significantly improve the user's bottom line. Finally, because the process and method of the present invention generally eliminates the need for manual manipulation of the boards in the sorting and bundling process, users of the present invention will see significant increases in safety and likely will see significant decreases in the amount of time lost to injury and disability caused by accidents occurring during the sorting and bundling process. It is therefore seen that the present invention provides a substantial improvement over those methods, systems and devices found in the prior art.

### BRIEF DESCRIPTION OF THE DRAWINGS

FIG. 1 is a perspective view of the board sorting and bundling apparatus of the present invention;

FIG. 2 is a top plan view of the present invention showing the board flow through the device;

FIG. 3 is a perspective view of the sorting section and the accumulating row section of the present invention;

FIG. 4 is a detailed side elevational view of the board drop channels of the present invention;

FIG. 5 is a detailed perspective view of the measuring section of the present invention showing the light curtain measuring the boards passing through the invention;

FIG. 6 is a detailed view of the computerized central processor 180 of the present invention showing the fill levels of various accumulator rows;

FIG. 7 is a detailed side elevational view of the initial end of the sorting section;

FIG. 8 is a detailed perspective view of the gates of the sorting section with a board being pushed therealong by an overhead lug;

FIGS. 9a and 9b are detailed side elevational views of the process by which a gate is opened to receive a board;

FIG. 10 is a detailed perspective view of the accumulating row section and the vacuum suction transport carriage in operation;

FIGS. 11 and 12 are, respectively, a detailed perspective view and a detailed side elevational view of the flipping device of the present invention;

FIG. 13 is an end elevational view of the bundling section of the present invention bundling a bundle;

FIG. 14 is a detailed perspective view of the bundling section of the present invention;

FIG. 15 is a detailed side elevational view of the bundling section;

FIG. 16 is a detailed perspective view of a completed bundle; and

FIGS. 17-22 are flowcharts which show the method of sorting boards of the present invention.

### DESCRIPTION OF THE PREFERRED EMBODIMENT

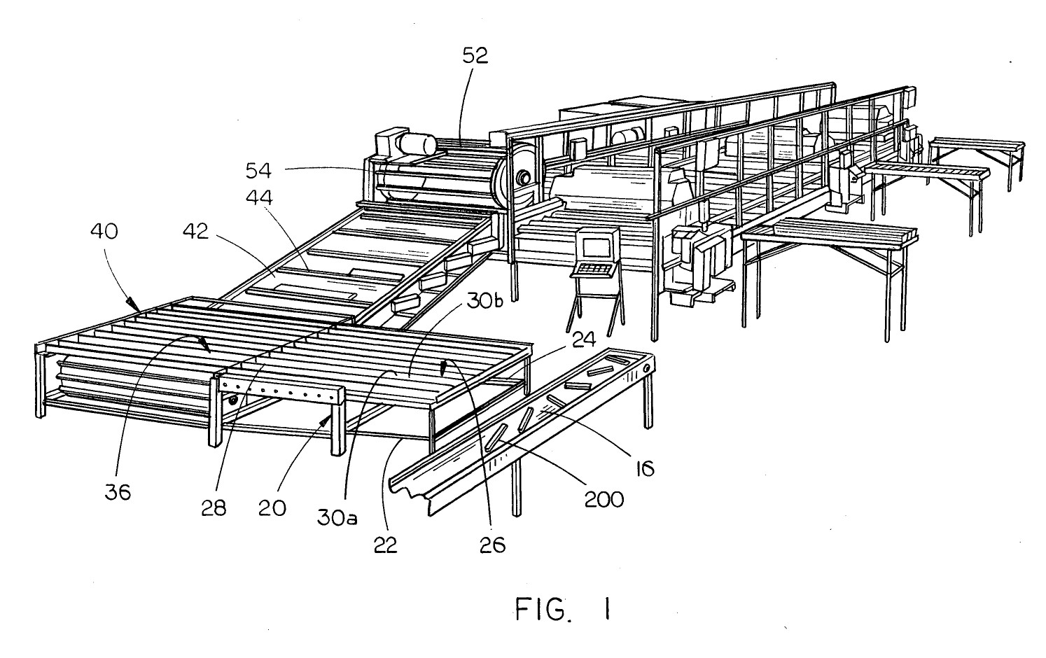

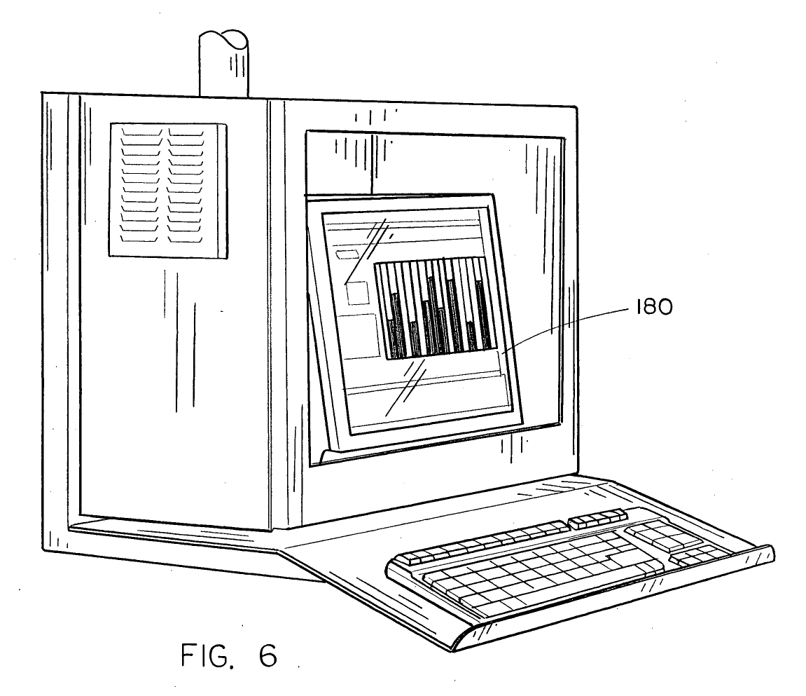

The selection and bundling apparatus 10 of the present invention is shown best in FIGS. 1-16 as including an infeed section 20, a measurement section 40, a sorting section 60, a row accumulating section 80, a bundling section 100 including one or more bundling devices 102 which further is operatively associated with a layer inverting device 120, and a vacuum suction transport carriage 140 operative to transport the accumulated rows of boards from the accumulator rows to the bundling section 100.

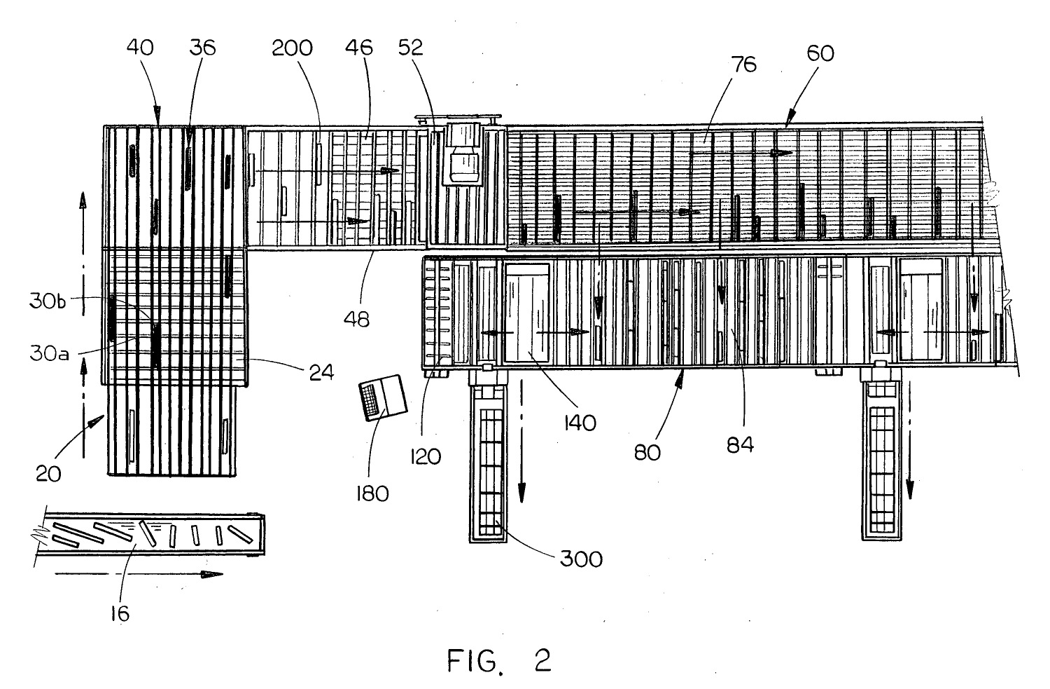

Referring now to FIGS. 1 and 2, infeed section 20 includes a support frame 22 supporting at least one inflow conveyor belt 24 having a forward end 26 and a rearward end 28. Mounted atop the conveyor belt are guide rails 30a and 30b which extend in convergent configuration to one another to guide the incoming board 200 down the inflow conveyor belt 24 towards rearward end 28 thereof. Preferably, the inflow conveyor belt 24 is operated at a speed which carries the boards 200 at a rate of approximately sixty (60) feet per minute, although it should be noted that this speed and in fact the other speeds of belts and drive wheels to be disclosed here may be changed or modified to adjust the operational characteristics of the present invention, and such modifications and changes should be understood to be a part of this disclosure. Also, each board 200 is preferably of uniform width and thickness, but has a variety of unequal, random lengths based upon cuts made to remove defects from the natural raw material, and it is these unequal lengths which has necessitated the development of the present invention.

The boards 200 are received as a plurality of random length boards which have been cut and processed earlier and are being delivered by conveyor belt 16 to the infeed section 20, and at this time or earlier in the cutting and finishing process, the grade of each board 200 must be determined. This may be accomplished by an automated grading scanner, a human grader inputting the grade with a switch or joystick or by a human placing each separate grade in a predetermined place such that the machine can determine its source, specifically by using different and multiple inflow conveyor belts each of which are associated with different grades of boards. Of course, the grading may also be entered directly into the central processor 180 which will keep an array of boards in its memory such that each board 200 passing through the present invention is uniquely tracked to ensure that differently graded boards are not included with the wrong grade. The boards 200 are then fed by a loading device or by hand into the board sorting and bundling device of the present invention, although the manual entry of the boards 200 is not currently recommended whereas the entry of the boards 200 by a preferred loading device is described herein.

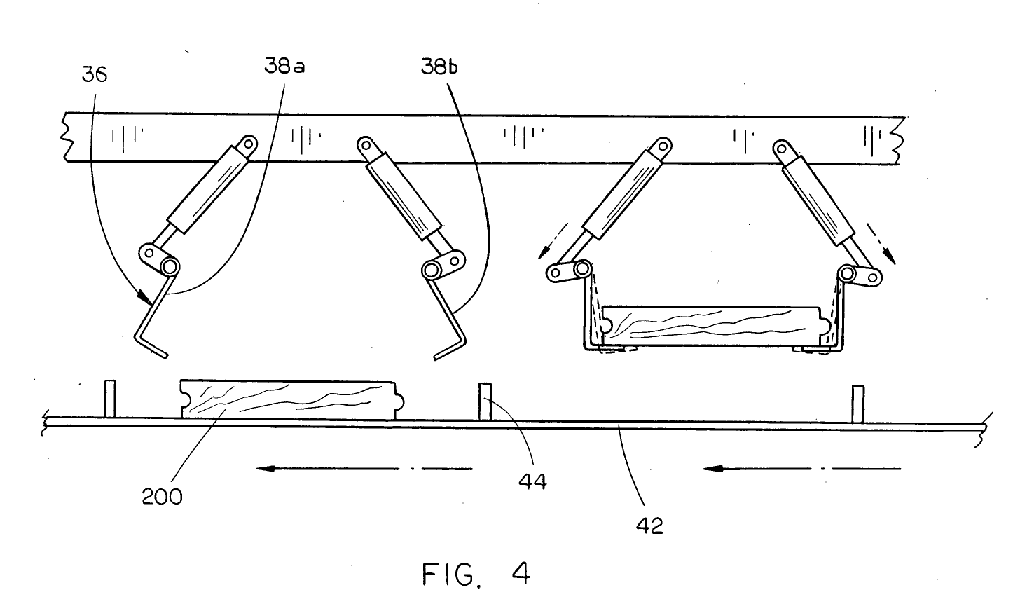

Mounted at the rearward end 28 of inflow conveyor belt 24 at the rear end of the convergent guide rails 30a and 30b are board drop channels 36, as shown best in FIG. 4, which are connected to the central processor 180 to identify when a board 200 is in the board drop channel 36 and which then waits until an appropriate drop time occurs when the board 200 may be dropped into the receiving portion of the measurement section 40. When that drop time occurs, the central processor 180 signals the board drop channel 36 to open to drop the board 200 into the receiving portion of the measurement section 40, and in the preferred embodiment, the board drop channel 36 would include drop doors 38a and 38b which would open to drop the board 200 upon receiving the drop signal from the central processor 180.

As shown in FIGS. 1, 2, 4 and 5, the next section into which the board 200 will pass is the measurement section 40 which, in the preferred embodiment includes a plurality of lugs 44 extending across the floor 42 of the device 10, a lug 44 being an upright transversely extended plate or bar, with each of the lugs being supported by a driven roller chain or another such generally constant speed drive mechanism on each end (i.e. opposite sides of the measurement section 40) such that the lugs 44 remain parallel and evenly spaced. Each lug 44 supports and pushes a single board 200, and the grade of each board 200 is noted by the computerized central processor 180 so that the processor knows what is the grade of each board. The boards are dropped into the measurement section 40 such that the boards 200 fall between the lugs 44, and the central processor 200 specifies the drop of each board 200 based on the sensed position of each of the lugs 44, thereby ensuring that only one board will be placed in front of each lug 44.

A series of longitudinally extended positioning rollers 46 are rotatably mounted adjacent and forward of the first section of floor 42 underneath the lugs 44. As the lugs 44 move the boards 200 held thereby forwards over the floor 42 of measurement section 40, the boards 200 contact the spinning positioning rollers 46 which drive each board 200 over to the inner side of the measurement section 40 against the inner guide wall 48 of the measurement section 40, as shown in FIG. 2, thus aligning the inner sides of each of the boards 200 against the inner guide wall 48 and thereby simplifying the board measuring process about to be described herein. Of course, it is not strictly necessary to include such positioning rollers 46, but it has been found that the alignment of the boards 200 against the inner guide wall 48 facilitates continued processing of the boards 200 traveling through the invention.

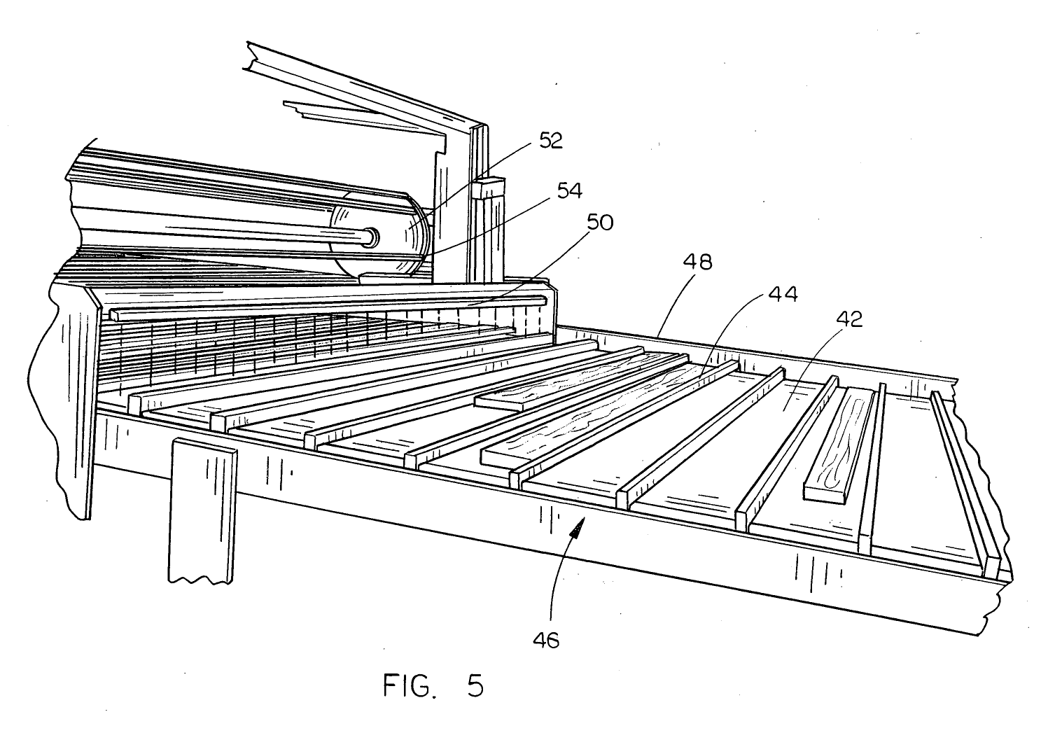

As shown best in FIG. 5, the main element of the measurement section 40 is the light curtain 50 which determines the length of each board and preferably includes a series of LED senders and receivers, as is well known in the trade, which determines the length of the board as it is conveyed by the lugs 44 along the floor 42 of the measurement section 40 from the loading device area to the sorting section 60, and this information is likewise transmitted and retained by the computerized central processor 180. The light curtain 50 may be constructed of a single transversely extended light bar or two or more light bars aligned collinearly with one another to provide a measurement device which extends across the entire floor 42 and can measure even the longest boards being sorted by the present invention. As was discussed previously, the board length measurement of the board 200 is transferred to the computerized central processor 180 which it enters the board array stored in the computerized central processor 180 along with the grading information for each board 200.

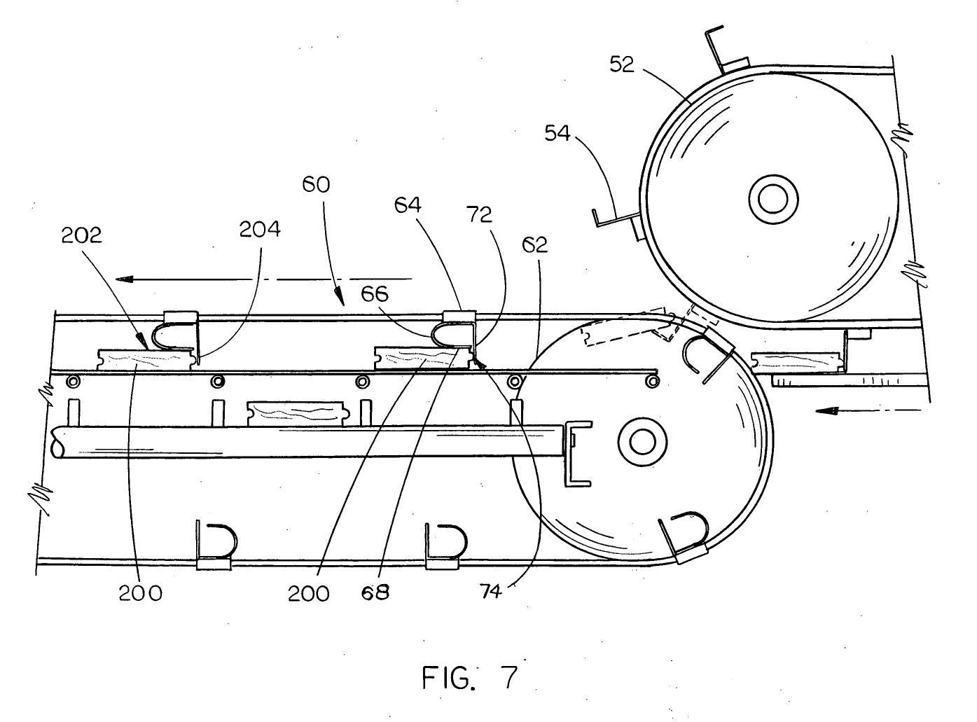

The board 200 is then transferred from the measurement section 40 to the sorting section 60 via a rotating transfer wheel 52. In the preferred embodiment, the rotating transfer wheel 52 rotates with an angular velocity which is generally identical to the speed of travel of the lugs 44, and would include a plurality of transversely extending board transfer bars 54 having generally L-shaped cross-sectional shapes which engage each of the boards 200 as they exit the measurement section and lift them out of the lugs 44 in which they were traveling, then carry them over to the sorting section 60 where each board 200 is dropped onto the floor 62 of the sorting section 60 for engagement by the pushing devices which move the boards 200 through the sorting section, as shown best in FIG. 7. However, it is not always necessary to provide the lifting and accelerating of the boards if there is a direct transfer from the end matcher or the measurement section, in which case the spacing and speed of the prior existing machine would need to be matched. In this case, one solution would be to provide a split chain section to accelerate and widen the spacing of the boards to allow sorting. However, one continuous chain on approximately 12″ centers may be used when standard loading procedures and devices are used, but the sorting section 60 of the present invention would still preferably be positioned below the measuring section 40 of the device.

In the preferred embodiment, each of the boards 200 would be engaged by an overhead lug 64 which is generally similar in design and construction to lugs 44 but is elevated above the floor 62, as shown best in FIGS. 7-9. Each of the overhead lugs 64 preferably includes a plurality of forwardly and downwardly depending “D”-springs 66 and associated downwardly depending push spring bars 72 each positioned rearwards of an adjacent “D”-spring 66 such that the lower curve 68 of the “D”-springs 66 engages the top surface 202 of the board 200 as the overhead lug 64 passes over and engages a board 200 dropped in front of the overhead lug 64 by the rotating transfer wheel, and the “D”-springs 66 press the board 200 downwards to keep the board 200 from bouncing or shifting as it is moved along the sorting section 60, and the rear edge 204 of the board 200 is engaged by the lower portion 74 of each of the push spring bars 72 to push the board 200 forwards along the sorting section 60 yet allow the board 200 to pop out of the lug 64 if the board 200 becomes jammed on the sorting section 60, thereby preventing the device 10 from being damaged should a jam take place. It has been found that the configuration of the overhead lugs 64, the “D”-springs 66 and associated downwardly depending push spring bars 72 is important to the operation of the present invention in order to properly and efficiently move the boards 200 through the sorting section 60, and although variations in the mechanisms used to move the boards 200 through the sorting section 60 are understood to be a part of this disclosure, it is preferred that the overhead lugs 64 be generally as described herein for optimal performance.

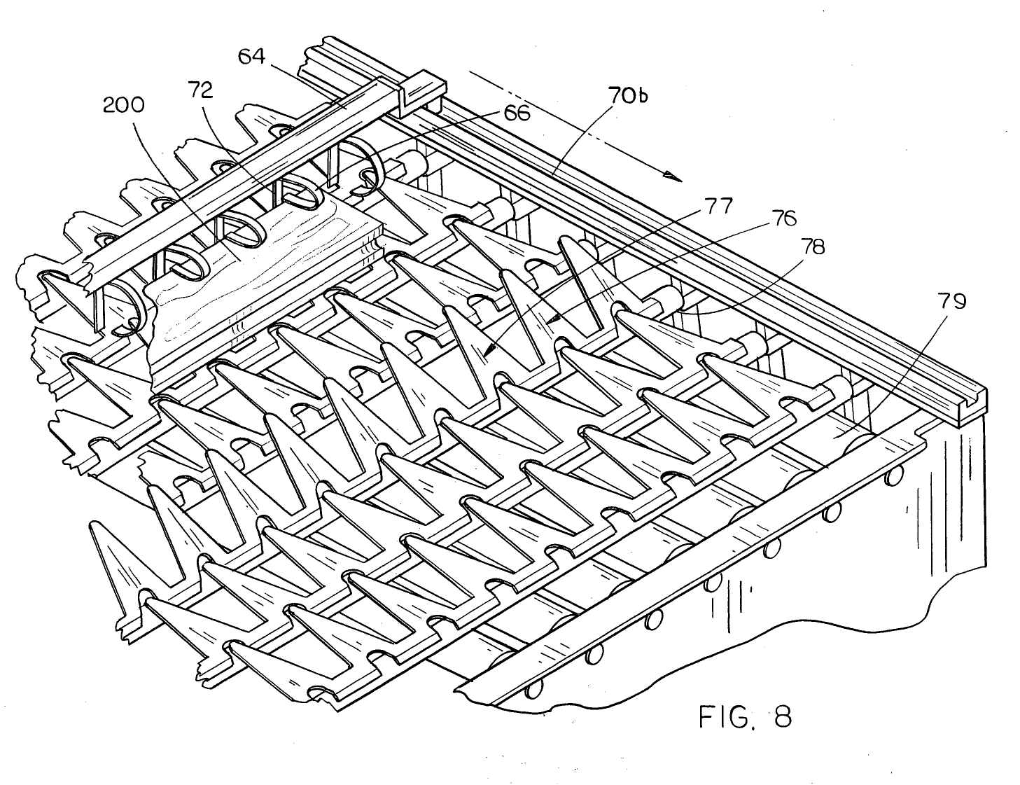

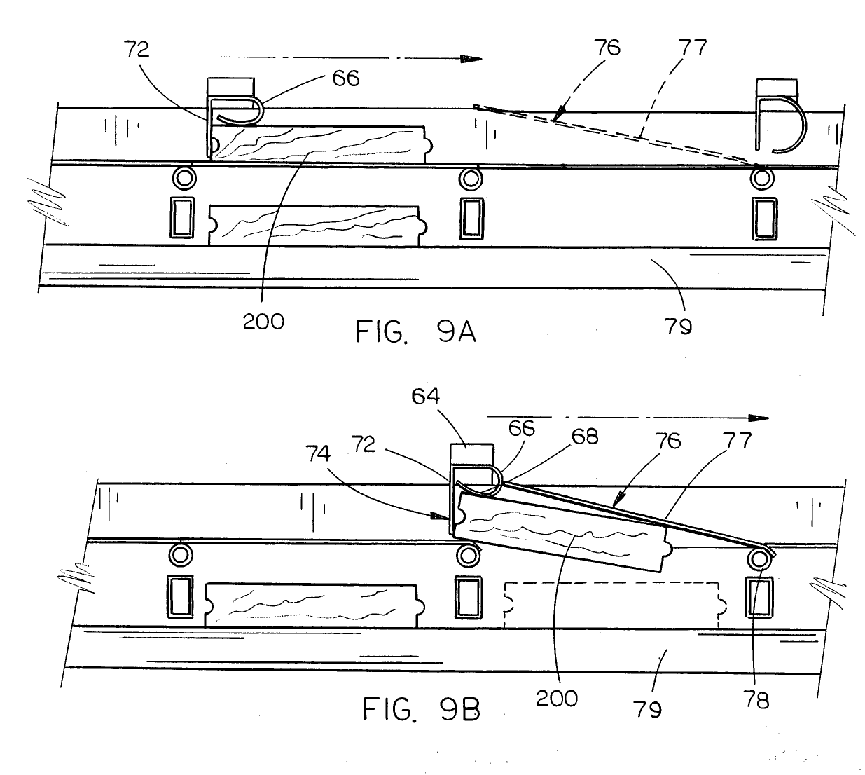

A series of transversely extending gates 76 are positioned in parallel configuration and pivotably mounted along the floor 62 of the sorting section 60 over which the board 200 is traveling, as shown in FIGS. 8 and 9, and as each board 200 enters the sorting section 60, the central processor 180 identifies the appropriate row into which the board 200 should be deposited by applying a sorting algorithm successively to each board 200 which will be described in more detail later in this disclosure. In the preferred embodiment, there are a plurality of gates 76 associated with each grade of board in a dynamic allocation design, and the processor 180 then activates the selected gate 76 on the sorting section 60, as shown in FIG. 9, so that the gate plate 77 pops up via activation of its associated pneumatic or hydraulic cylinder 78, the board 200 hits the gate plate 77 and begins to fall down below the gate 76, and the gate plate 77 then shuts by reverse activation of the pneumatic cylinder 78 thus forcing the board 200 downwards onto a set of transfer belts or rollers 79 which are in constant rotational motion to drive the board 200 transversely between the gates 76 along the selected gate line over to the accumulating row section 80. Because the pivoting mount of each of the gates extends below the level of the gate plate 77, the space directly beneath the gate plate 77 accommodates the board 200 which rests on the transfer rollers 79 so that the board 200 travels between the gate pivots underneath the selected gate 76 over to the accumulator row section 80 described hereinafter.

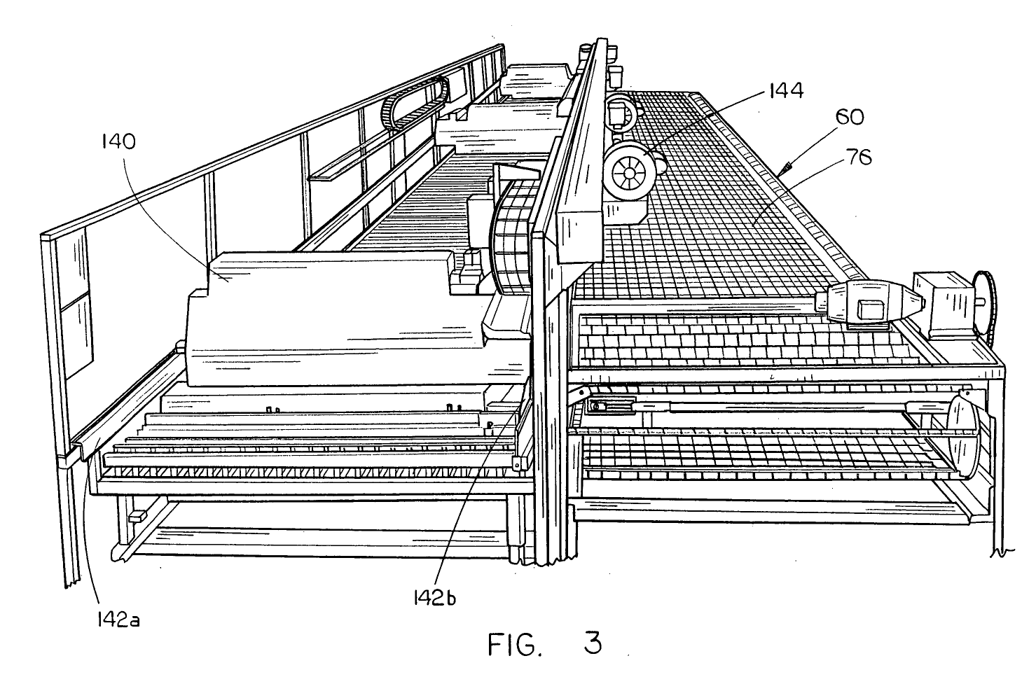

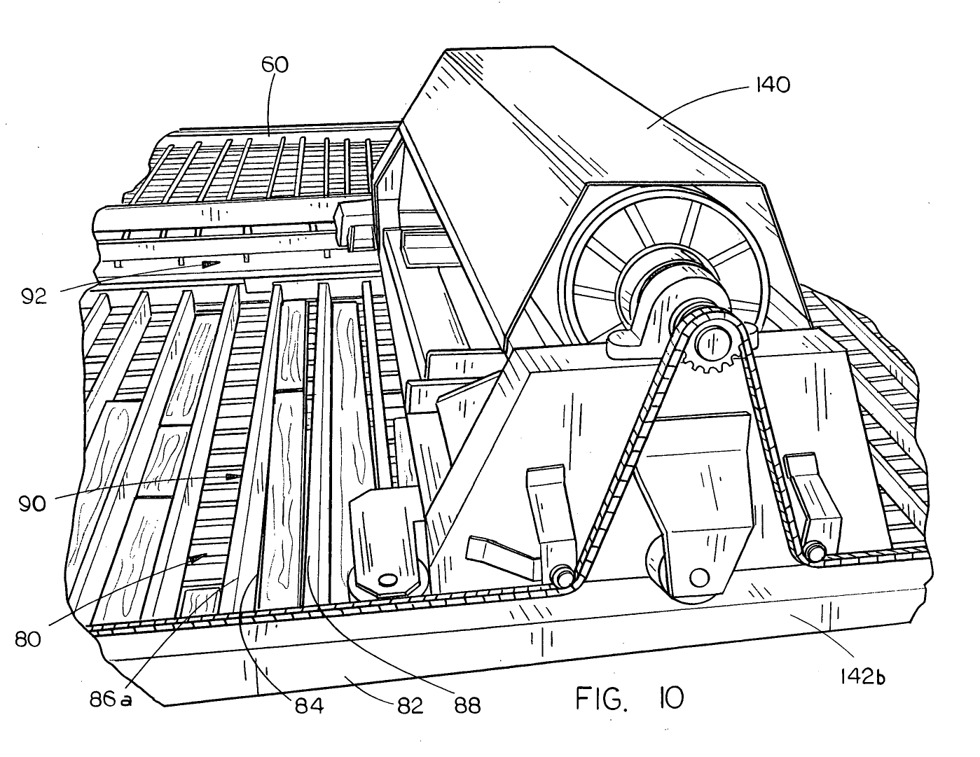

The accumulator row section 80 in the preferred embodiment is shown best in FIGS. 3 and 10 as including a plurality of transversely extending accumulating rows 84 separated by upright bars 86 and 88 which extend parallel with one another and are adjustably mounted on the accumulating row section frame 82 such that the width of the accumulating rows 84 may be adjusted by a row width adjustment mechanism 90 by the user of the present invention to accommodate boards 200 of different widths. The transfer rollers 79 engage the boards 200 and push them into the selected accumulating row 84, and it should be noted that to ensure proper transfer of the boards 200 from the gates 76 to the accumulating rows 84, it may be necessary to provide adjustable transfer guide walls 92 which extend between the ends of the gates 76 and the feed openings of the accumulating rows 84, although the precise nature of those transfer guide walls 92 is not particularly critical to the operation of the present invention so long as the guide function of transferring the boards 200 from the sorting section 60 to the accumulating row section 80.

As the board enters the selected row 84 of the accumulating row section 80, the central processor 180 tracks the status of each accumulating row. Once the set of boards 200 within a particular row 84 reaches a total length which falls within the predetermined target length range, the central processor 180 dispatches a vacuum suction transport carriage 140 which is supported on rails 142a and 142b or tracks above the accumulating row section 80 and travels perpendicular to the positioning of the row of boards within the accumulating rows 84 so that the accumulating row 84 where the entire row of boards is to be picked up is easily accessed, picked up and supported by the carriage 140, as shown in FIG. 10. In the preferred embodiment, the vacuum suction transport carriage 140 includes a carriage frame 142 which includes a set of rail-engaging wheels 152a and 152b mounted on opposite ends of the carriage 140. The vacuum suction device 144 includes at least two rows of suction cups or pads 146a and 146b connected to a vacuum source 148 for generating a significant degree of suction at each of the two rows of suction cups or pads 146a and 146b. The two rows of suction cups or pads 146a and 146b are adjustably mounted on the carriage frame 142 such that the spacing between the rows of suction cups or pads 146a and 146b may be adjusted to initially pick up two rows of boards 200 and then the rows of suction cups or pads 146a and 146b may be moved towards one another to bring the two rows of boards 200 into adjacent contact with one another prior to being moved to the bundling section 100. In the preferred embodiment, however, it should be noted that the carriage 140 will have three rows of suction cups so that three rows of boards 200 may be picked up and transferred to the bundling section 100 at the same time. Also, the present invention contemplates simultaneous use of two or more carriages 140 which travel over the accumulating row section 80 and transfer the collected rows of boards 200 to one of several bundling sections 100 including one or more bundling devices 102 which will be described later in this disclosure.

Since the preferred bundle size in most flooring mills is 3 rows wide by 4 or 5 layers high, the vacuum suction transport carriage 140 of the present invention is preferably designed to pick up and handle three (3) rows at one time. Thus, one trip of the carriage 140 will place one layer of product onto the bundle. Wider width flooring may be stacked 2 or 1 row wide, but rarely would a bundle have more than 3 rows in a layer. The accumulator rows 84 are spaced according to the widest width of flooring the machine is designed to handle. For example, 4″ wide flooring would normally require the accumulator rows 84 to be on 6″ centers, while 3.25″ flooring would require 5.25″ centers for the accumulator rows 84. However, of course, these distances may vary slightly with design details. Ideally, the rows need to be stacked on the bundles closer together to conserve conveyor space, allow for easier compaction of the columns of product, and also because the rows coming out of the flipper unit, as described later herein, are already close together. The vacuum suction transport carriage 140 therefore needs to be able to pick the rows up on 6″ or 5.25″ centers so that it is able to pick up 2 or 3 rows at a time if they happen to be next to each other. In fact, the computerized central processor 180 is programmed to give preference to complete rows which are being held in adjacent accumulator rows 84 to take advantage of this feature of the vacuum suction transport carriage 140. Of course, it should be noted that as the present invention will sort boards of only one width at a time, the row centers will not change once they are set by the computerized central processor 180 until the apparatus is cleared and begins sorting boards of a new width.

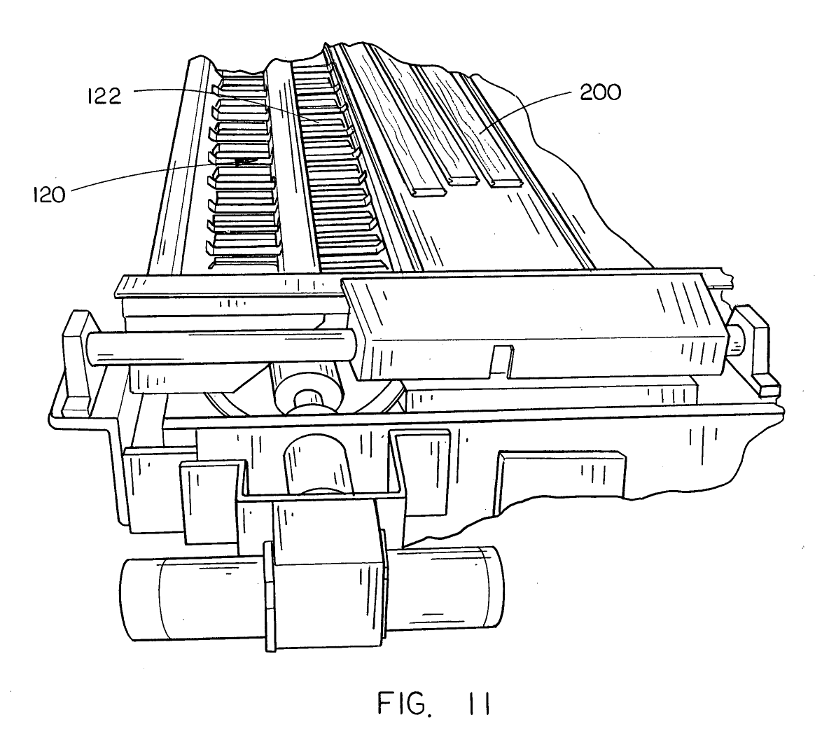

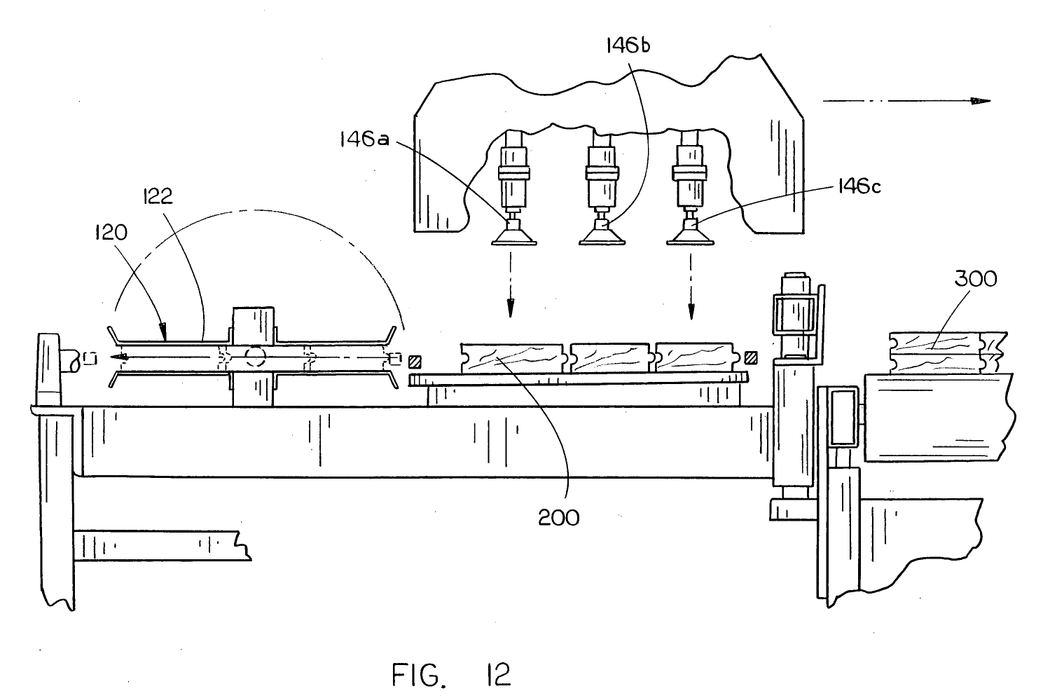

One, two or three rows are then picked up by the carriage 140 and the entire layer of two or three rows is then transferred by the carriage 140 to the bundling section 100, as shown in FIGS. 11-15 where the appropriate selected number of layers are placed atop one another to form the layered bundle of boards, which is usually three to five layers of two to three boards each. The top layer of boards is then deposited in a layer inverting mechanism 120, shown best in FIGS. 11 and 12, where it is flipped to orientate the bottom side of the layer face up, and the flipped layer is then transferred back to the bundle 300 in order to protect the top face of the finished bundle. Briefly, the layer inverting mechanism 120 includes a board row receiving assembly 122 which receives the top layer of boards and secures them therewithin. The board row receiving assembly 122 then rotates about its longitudinal axis 180° so that the top layer of boards is inverted with the bottom side of the layer projecting upwards. The board row receiving assembly 122 then releases the top layer of boards, and the vacuum suction transport carriage 140 reengages the top layer of boards to transport it to the top of the bundle being formed in the bundling section 100, and the bundle 300 is then ready for final packaging prior to shipping.

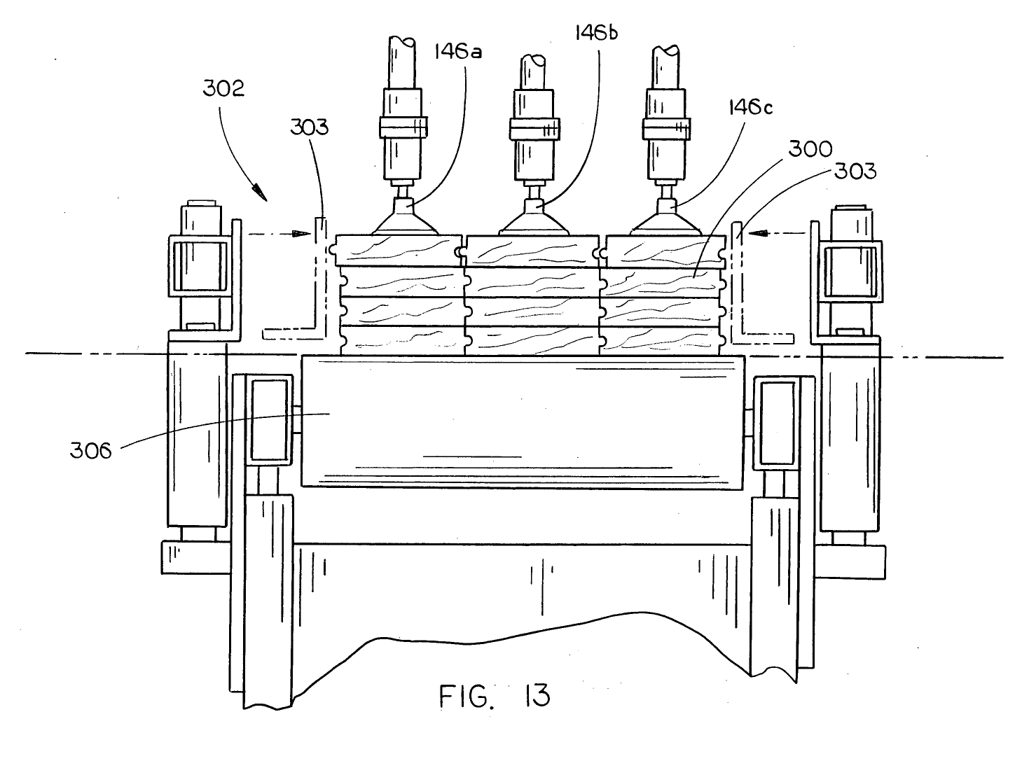

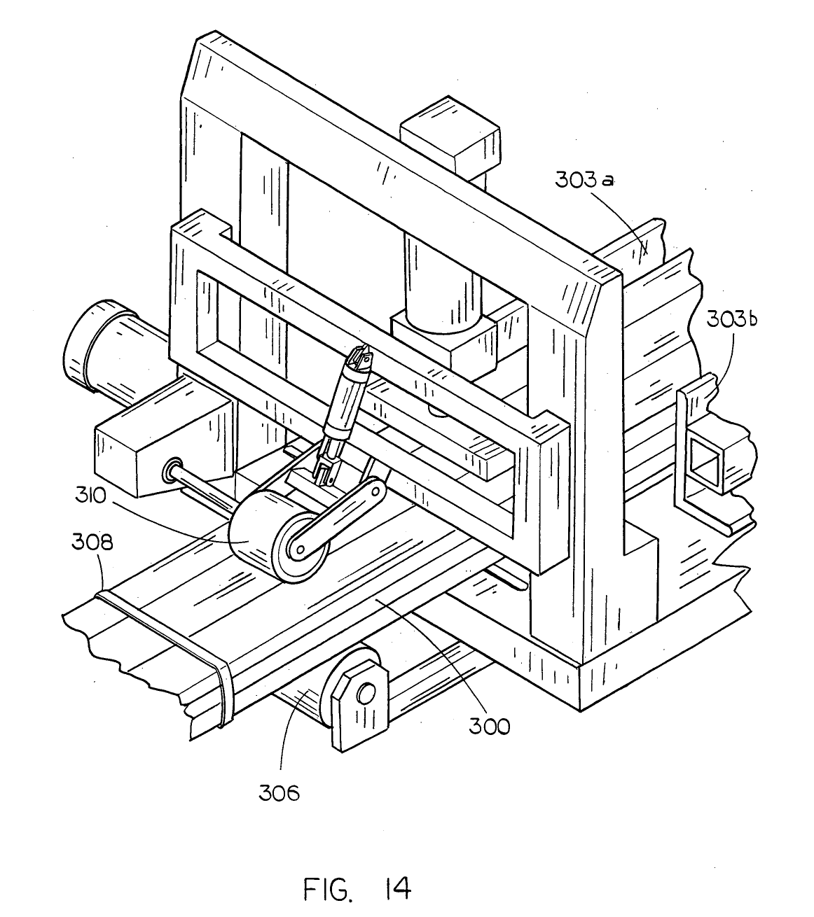

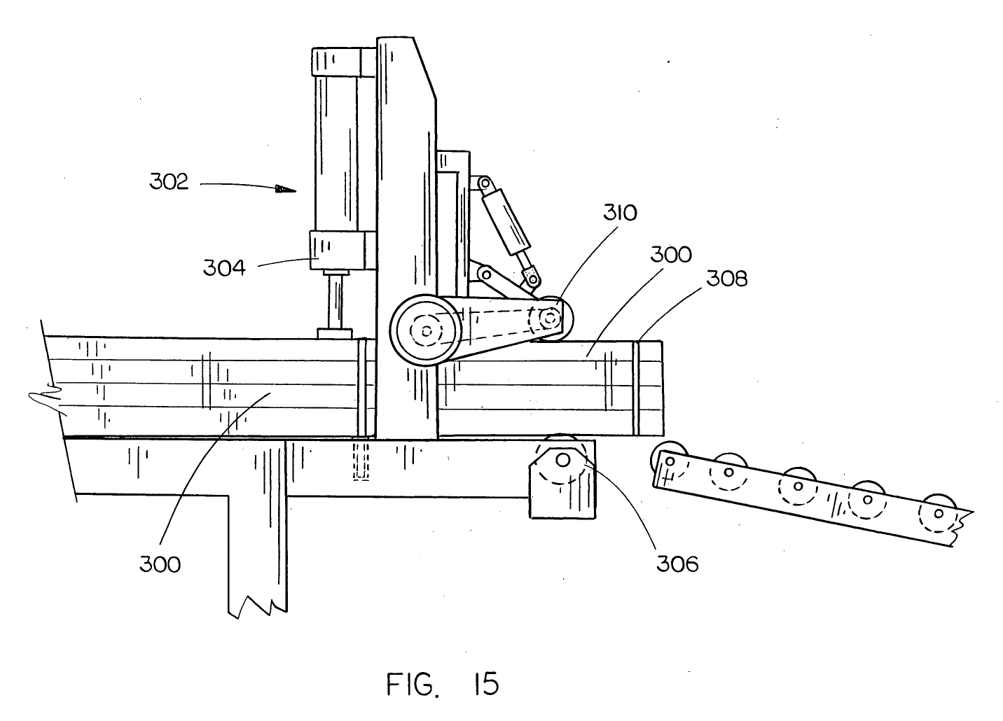

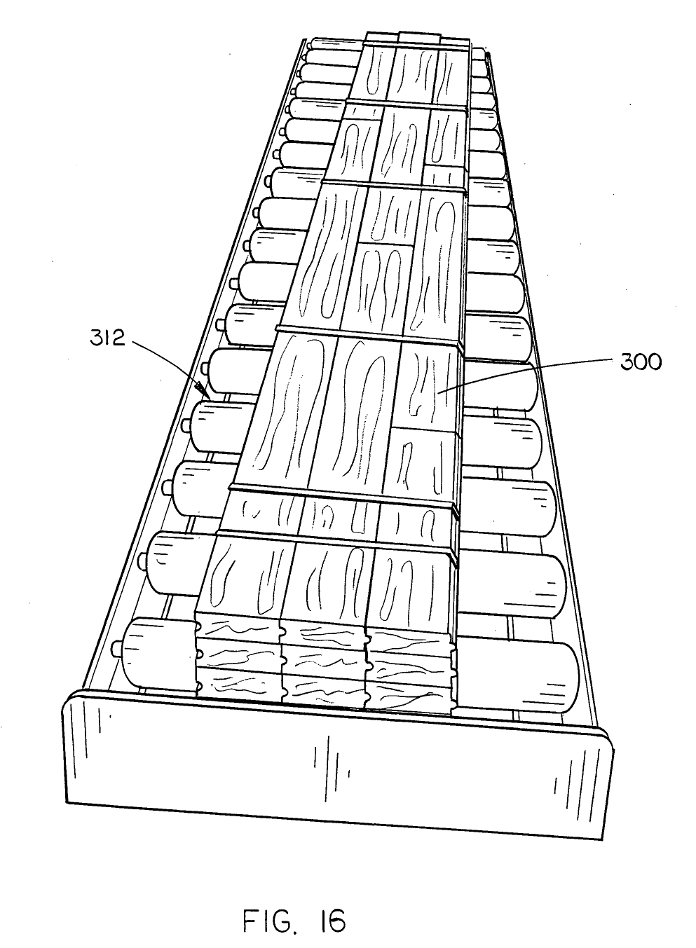

The bundle 300 is then crammed together by opposing cramming plates 303a and 303b, as shown in FIGS. 13 and 14, and top press plate 304 which tightly bunch and align the layers of the bundle 300, and the bundle 300 is then wrapped by appropriate securement banding straps 308 to secure the bundle 300 for transport. In the preferred embodiment, the bundling device 302 would include a banding device 306 operative to extend and secure a securement banding strap 308 around the bundle 300 at a series of spaced locations along the length of the bundle 300 as the bundle 300 is moved forwards by a bundle feed conveyor 306 and is held in contact therewith by a tensioning roller 310 which presses on the top layer of the bundle 300 as shown best in FIGS. 14 and 15. The bundle 300 is then prepared for distribution and shipping thereof as it exits onto a support table 312, as shown best in FIG. 16.

The important features of the present invention is that it is designed to take in a board 200 and determine which accumulating row 84 to deposit the board 200 in, without requiring prior buffering as is necessary with almost all other prior art methods and devices. In the present invention, the only available storage is in the plurality of accumulator rows 84. Typically between 16 and 24 rows need to be allocated for each grade, with only 6 or 8 rows needed to accumulate shorts. Rows are not predetermined to handle just one grade, but are dynamically allocated as needed by the sorting algorithm, taking into account the proximity of the bundle conveyors 306 designated to handle the particular grade of board 200. The difficult part of the process is to find a place for each board 200 while forming rows within tolerance and not running out of rows. It has been found, however, that the use of at least sixteen accumulating rows 84 for each grade will permit sorting and accumulating of over ninety to ninety-five percent (90% to 95%) of the boards 200 passing through the apparatus, and the use of more accumulating rows 84 will bring the number of unsorted boards 200 down even more.

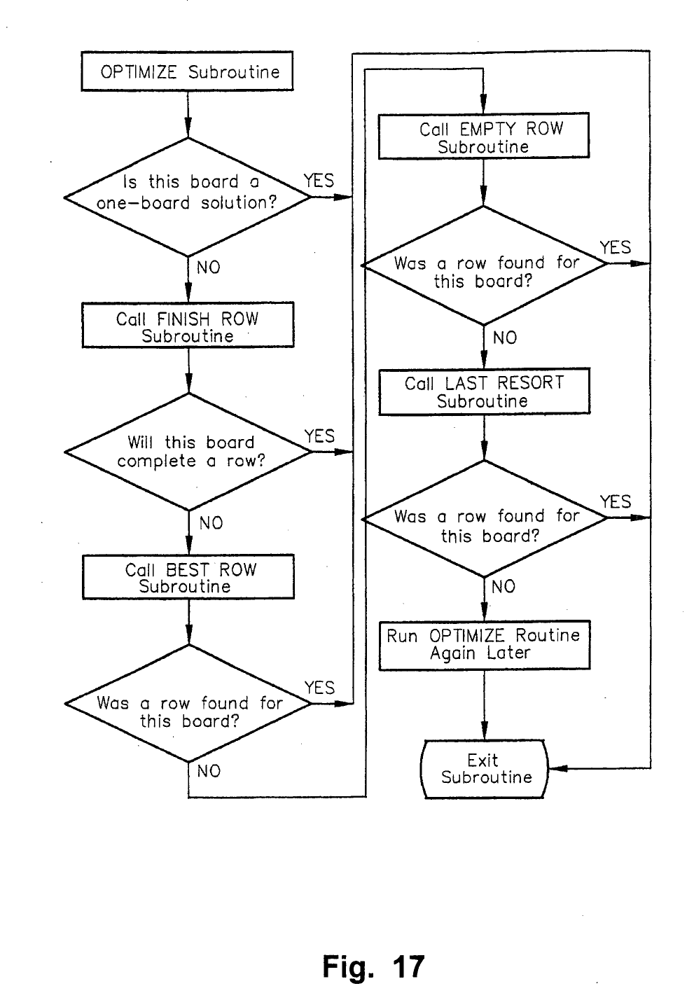

To better understand the overall process of selecting, sorting, and bundling various lengths of boards, an overall view of the method, as shown best in FIGS. 17-22, will now be described. Once a board 200 enters the infeed of the present invention, it is butted to the inner side of the infeed section and the board then may move on to the grading area unless grading has already taken place.

In one embodiment of the present invention, each board being carried on the device 10 is assigned to a grader based on the number of personnel available for grading. For example, if there were only a single grader available, he or she would grade each and every board passing through the device, whereas two graders would alternate grading every other board and three graders would each grade every third board, and so on and so forth. Once the board has been graded by the grading personnel, that information is stored in the appropriate register of the slat array and is available to the computer program which associates the particular grade with each and every selected board passing through the device.

The board then moves underneath the light curtain which determines the length of each piece of board and this information is coordinated by the computing device to enter into the board array so that the computer now associates each particular board with a length and grade in the board array. A shaft encoder and a slat sensor determines the starting point for the lugs and then the positioning and location of where the particular slats are located is known by the computer thereby determining the position of the board within the slat to see if it is at or near the first row of the appropriate grade sorting area as the board travels along the device. Once the board reaches the selected grade sorting area, the sorting algorithm is called by the computing system to determine the location into which the board should be placed.

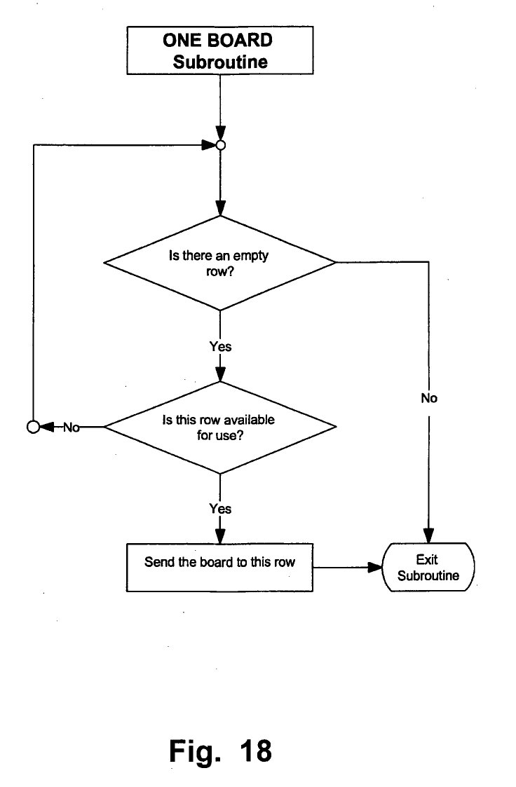

The sorting algorithms, specifically the optimization subroutines, are shown best in FIGS. 17-22 as including the overall optimization subroutine and the sorting subroutines for the various attempts to place the board in an accumulating row. As shown best in FIG. 17, the optimization subroutine asks a series of yes-no questions to determine the subroutine solution to be called by the program to sort the board into the appropriate row. As the boards passing through the device are of various lengths, the series of inquiries which must be made by the optimization subroutine are designed to determine the appropriate location for the board in a sorting row and the subroutine begins by asking is this board a one-board solution, which basically is inquiring is this board of sufficient length to occupy an entire row by itself. In a standard seven foot or eight foot long bundle, if the board is within a few inches of the total seven or eight foot length of each row, the board will be a one-board solution and the optimization subroutine then calls the one-board subroutine, as shown in FIG. 18. The one-board subroutine is designed to find the first empty row available for use and the program sends the board to that first empty row, and the subroutine is only used for boards long enough to provide a one-board solution as discussed herein.

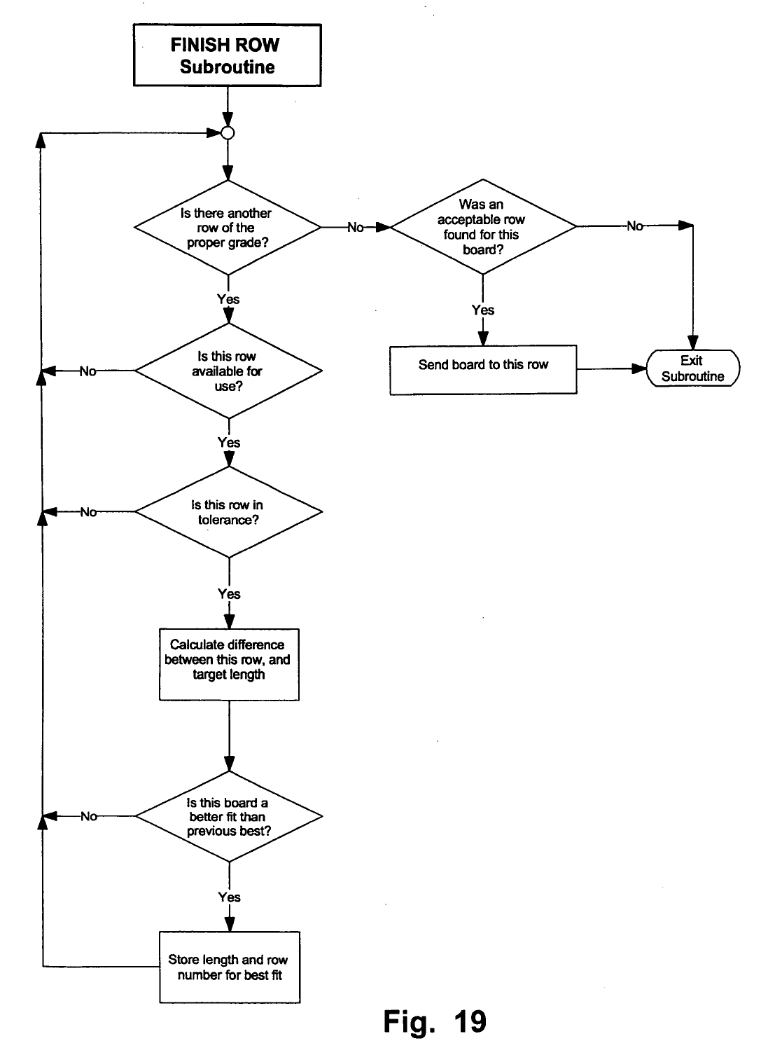

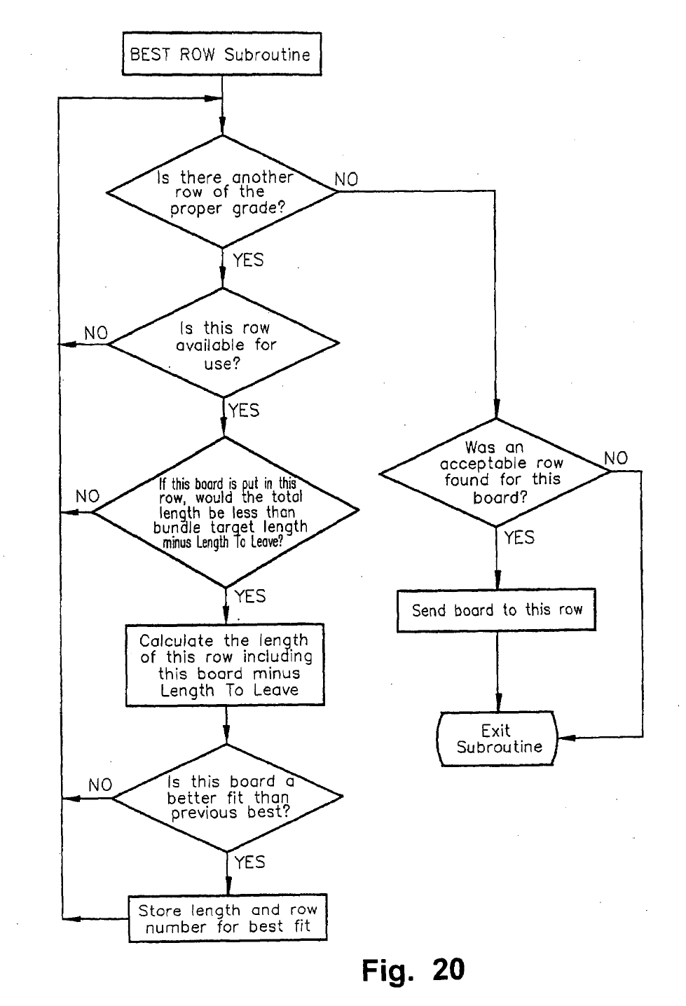

If the board is not a one-board solution, the finish row subroutine shown best in FIG. 19 is called, which is designed to find the best row for the board currently being processed to fill the row, i.e. one which is closest to the target length. The optimization subroutine then asks if the board under scrutiny will complete a row and if so the subroutine ends and begins to process the next board in line. If, however, the board will not complete a row, the optimization subroutine calls the best row subroutine which is shown in FIG. 20, and the detailed inquiries are disclosed in the flowchart of that figure and further discussion is not deemed necessary.

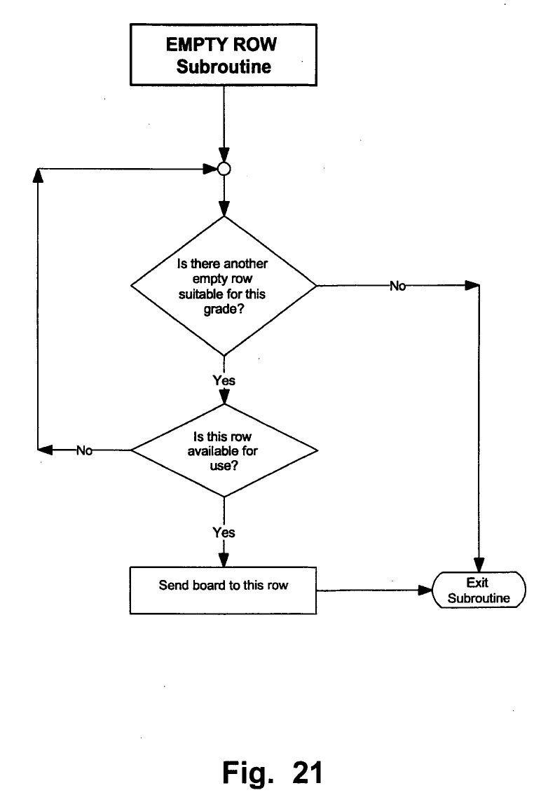

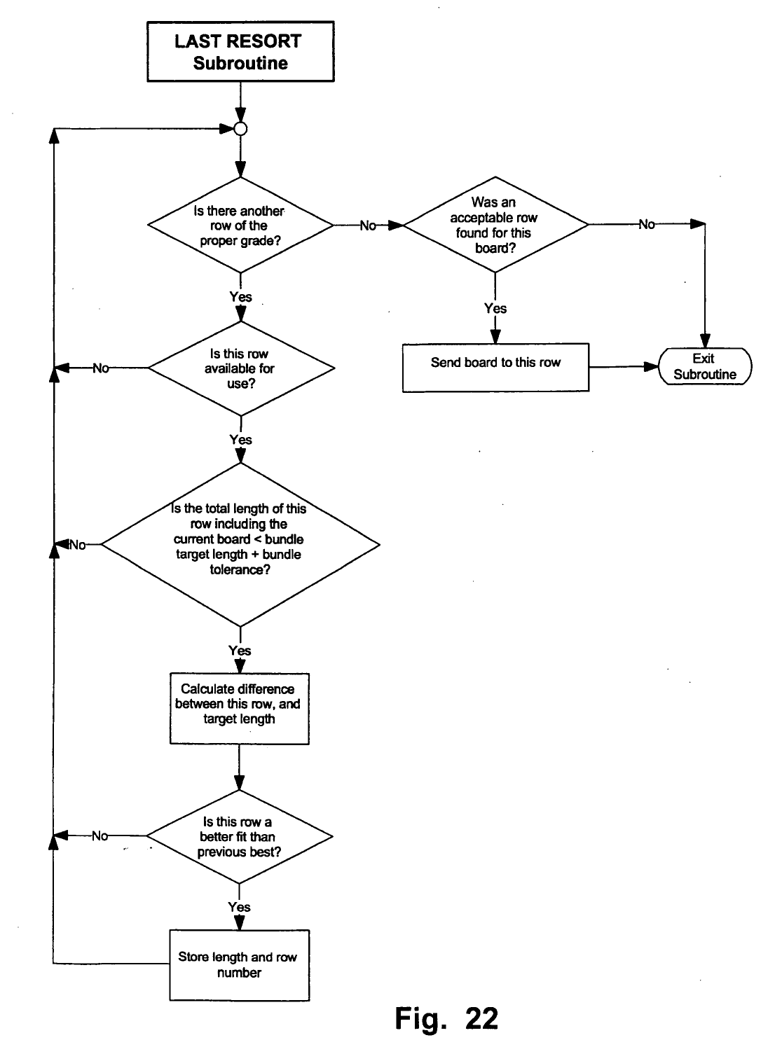

The best row subroutine, after running, then returns to the optimization subroutine which inquires if a row was found for the board under scrutiny, and if one has been found, the optimization subroutine ends and then moves on to the next board to be sorted. If, however, a row was not found for that board, the empty row subroutine of FIG. 21 is then called which sends the board to any empty row in order to start a new row for the sorting mechanism. The optimization subroutine then again inquires if a row was found for that board, and, if so, the optimization subroutine ends and moves on to the next board in line. If, however, a row was not found for the board, the last resort subroutine shown best in FIG. 22 is called which attempts to find the best remaining row for the board to go into. This is the final attempt used by the optimization subroutine, and in fact by the overall sorting algorithm, to attempt to place the board in a row in the device, although this sorting attempt will continue so long as the board remains in the apparatus, i.e. until the board passes the last possible sorting row. In the unlikely event that a location cannot be found into which the board will fit, however, the board is allowed to exit the end of the machine for manual sorting at a later time and the optimization subroutine is moved on to the next board in line for sorting thereof. In the preferred embodiment, it has been found that with approximately twenty-four rows available for each grade of a board to be sorted, an extremely limited number of boards will need to be sorted after the entire optimization subroutine has been processed, and it is expected that the operator of the present invention will not have to actually manually sort the boards which exit the end of the device, but instead will simply run those boards through the invention again so that they may be properly sorted through application of the sorting algorithm to those boards thereby finding an appropriate row in which those boards may be placed.

Once the designated row has been determined for a board, the board drops into the appropriate location and is gathered in the proper accumulator row. Once three full rows of a given grade are accumulated, the vacuum carriage previously described removes the rows from the accumulator and places them on the bundle conveyor or on the flipper device as was described previously.

If the bundle layer is to be the top layer of the bundle, it is pushed into the flipping device, rotated one hundred eighty degrees and pushed back out of the flipper in order to place the bottom of the boards in a “face up” position for transport purposes. The layer is then transported by the vacuum carriage to the bundle conveyor and the completed bundle is compacted horizontally by the cramming mechanism and resulting bundle is then sequenced through the banding device as was described previously. It is believed that this overall view of the “life of a board” should provide valuable assistance to persons wishing to understand operation of the method and apparatus of the invention, and application of the various detailed selecting, sorting and bundling aspects of the present invention to boards passing therethrough should be understood to be disclosed by the above disclosure and through reference to the drawings accompanying this document.

It is to be understood that numerous additions, modifications and substitutions may be made to the improved board sorting and bundling apparatus and method 10 of the present invention which fall within the intended broad scope of the appended claims. For example, the size, shape, and construction materials used in connection with the present invention may be modified or changed so long as the intended functional characteristics of the present invention are generally maintained. Also, although the infeed section 20, measurement section 40, sorting section 60, accumulating row section 80, bundling sections 100, vacuum suction transport carriage 140 and central processor 180 have been described as including certain particular functional elements and features, modification of these elements and features which do not significantly degrade or destroy the functionality of the various sections should be understood to fall within the intended broad scope of the appended claims. Furthermore, modifications to the specific application of the method elements of the present invention should be understood to be a part of this disclosure so long as the general sorting algorithms used in the present invention are not significantly degraded or destroyed. Finally, although the present invention has been described for use in connection with the sorting and bundling of wood floor boards, it should be noted, of course, that it may be used for any purpose for which the apparatus and method are suited, and it is expected that the present invention may be used for sorting of other wood board types in the same efficient and safe manner.

There has therefore been shown and described an improved board sorting and bundling apparatus and method 10 which accomplishes at least all of its intended objectives.

I claim:

1. A method for selecting and sorting a plurality of random length boards to form at least one row of boards having a total length within a predetermined target length range, said method comprising the steps:
measuring the length of each of a plurality of random length boards;
feeding each of the plurality of random length boards into a programmable sorting device;
sorting each of the plurality of random length boards via said programmable sorting device into a plurality of accumulating rows to fill at least some of said plurality of accumulating rows with selected boards from the plurality of random length boards such that the selected boards in at least some of said plurality of accumulating rows form rows of boards having a total overall length within a predetermined target length range;
selecting and transferring each row of boards having a total overall length within a predetermined target length range via a board row transfer means from at least one of said plurality of accumulating rows to a bundling device; and
bundling the selected and transferred rows of boards via said bundling device by generally bunching, aligning and securing the rows of boards in a generally longitudinally aligned board row bundle.

2. The method for selecting and sorting a plurality of random length boards of claim 1 wherein said step of measuring the length of each of a plurality of boards further comprises providing an LED light curtain including a series of LED senders and receivers operative to determine the length of the board.

3. The method for selecting and sorting a plurality of random length boards of claim 1 wherein said step of sorting each of the plurality of boards via said programmable sorting device comprises determining if the board being sorted is a one-board solution and if so, sorting the board into an empty one of said plurality of accumulating rows.

4. The method for selecting and sorting a plurality of random length boards of claim 3 wherein said step of sorting each of the plurality of boards via said programmable sorting device further comprises determining if the board being sorted will fit into one of said plurality of accumulating rows already having at least one board therein without exceeding the predetermined target length range and if so, sorting the board into the one of said plurality of accumulating rows providing substantially the best fit for the board to bring the total length of the row of boards therein closest to or within the predetermined target length range.

5. The method for selecting and sorting a plurality of random length boards of claim 4 wherein said step of sorting each of the plurality of boards via said programmable sorting device further comprises determining if the board being sorted will not fit within any of said plurality of accumulating rows already having at least one board therein without exceeding the predetermined target length range and if so, sorting the board into an empty one of said plurality of accumulating rows.

6. A method for selecting and sorting a plurality of random length boards to form at least one row of boards having a total length within a predetermined target length range, said method comprising the steps:
measuring the length and grade of each of a plurality of random length boards;
feeding each of the plurality of random length boards into a programmable sorting device;
sorting each of the plurality of random length boards via said programmable sorting device into a plurality of accumulating rows to fill at least some of said plurality of accumulating rows with selected boards of the same grade from the plurality of random length boards such that the selected boards in at least some of said plurality of accumulating rows form rows of boards of the same grade and having a total overall length within a predetermined target length range;
selecting and transferring each row of boards of the same grade and having a total overall length within a predetermined target length range via a board row transfer means from at least one of said plurality of accumulating rows to a bundling device; and
bundling the selected and transferred rows of boards via said bundling device by generally bunching, aligning and securing the rows of boards in a generally longitudinally aligned board row bundle of boards of the same grade.

7. The method for selecting and sorting a plurality of random length boards of claim 6 wherein said step of sorting each of the plurality of boards via said programmable sorting device comprises determining if the board being sorted is a one-board solution and if so, sorting the board into an empty one of said plurality of accumulating rows allocated to the grade of the board being sorted.

8. The method for selecting and sorting a plurality of random length boards of claim 7 wherein said step of sorting each of the plurality of boards via said programmable sorting device further comprises determining if the board being sorted will fit into one of said plurality of accumulating rows allocated to the grade of the board being sorted and already having at least one board therein without exceeding the predetermined target length range and if so, sorting the board into the one of said plurality of accumulating rows providing substantially the best fit for the board to bring the total length of the row of boards therein closest to or within the predetermined target length range.

9. The method for selecting and sorting a plurality of random length boards of claim 8 wherein said step of sorting each of the plurality of boards via said programmable sorting device further comprises determining if the board being sorted will not fit within any of said plurality of accumulating rows allocated to the grade of the board being sorted already having at least one board therein without exceeding the predetermined target length range and if so, sorting the board into an empty one of said plurality of accumulating rows allocated to the grade of the board being sorted.

10. The method for selecting and sorting a plurality of random length boards of claim 9 wherein said step of sorting each of the plurality of boards via said programmable sorting device further comprises determining if the board being sorted will not fit within any of said plurality of accumulating rows allocated to the grade of the board being sorted and already having at least one board therein without exceeding the predetermined target length range and that there are no remaining empty ones of said accumulating rows allocated to the grade of the board being sorted and if so, sorting the board into an empty one of said plurality of accumulating rows and reallocating the selected empty one of said plurality of accumulating rows to the grade of the board being sorted.

11. A method for selecting and sorting a plurality of random length boards to form at least one row of boards having a total length within a predetermined target length range, said method comprising the steps:
measuring the length of each of a plurality of random length boards;
feeding each of the plurality of random length boards into a programmable sorting device;
sorting each of the plurality of random length boards via said programmable sorting device into a plurality of accumulating rows to fill at least some of said plurality of accumulating rows with selected boards from the plurality of random length boards such that the selected boards in at least some of said plurality of accumulating rows form rows of boards and having a total overall length within a predetermined target length range, said sorting step further comprising the steps;
determining if the board being sorted is a one-board solution and if so, sorting the board into an empty one of said plurality of accumulating rows;
determining if the board being sorted will fit into one of said plurality of accumulating rows already having at least one board therein without exceeding the predetermined target length range and if so, sorting the board into the one of said plurality of accumulating rows providing substantially the best fit for the board to bring the total length of the row of boards therein closest to or within the predetermined target length range; and
determining if the board being sorted will not fit within any of said plurality of accumulating rows already having at least one board therein without exceeding the predetermined target length range and if so, sorting the board into an empty one of said plurality of accumulating rows.
